(19) United States
(12) Patent Application Publication
(10) Pub. No.: US 2003/0093373 A1
(43) Pub. Date: May 15, 2003

(54) Systems and methods for providing invoice-based billing information associated with a credit card transaction

(76) Inventors: Kellie M. Smirnoff, Marietta, GA (US); Cynthia L. Burt, Norwalk, CT (US); Scott T. Mulloy, Stamford, CT (US); Matthew Albano, Yorktown Heights, NY (US); John H. Berquist III, Bayside, NY (US); Delano W. Ladd III, Rye, NY (US)

Correspondence Address: BUCKLEY, MASCHOFF, TALWALKAR, & ALLISON, 5 ELM STREET, NEW CANAAN, CT, 06840, US

(21) Appl. No.: 10/055,393

(22) Filed: Nov. 13, 2001

(51) Int. Cl. G06F 17/60

(52) U.S. Cl. 705/40

(57) ABSTRACT

Systems and methods are disclosed to provide invoice-based billing information associated with a credit card transaction. According to one embodiment, information associated with a customer's credit card transaction is received. For example, transaction information, including a project identifier, may be received from merchant device or a credit card account device. It is then arranged through a communication network for invoice-based billing information associated with the credit card transaction to be provided via a customer device. For example, invoice-based billing information may be displayed to the customer via a Web site.

### FIELD

The present invention relates to credit card transactions. In particular, the present invention relates to systems and methods for providing invoice-based billing information associated with a credit card transaction.

### BACKGROUND

A customer may receive billing information in a number of different ways. In the case of a commercial credit card account, for example, a customer typically receives a monthly statement listing a number of different transactions that occurred during the month. The statement also includes a total balance that is now due in connection with the account (e.g., a single amount associated with a number of different transactions). The customer can then provide a payment against the total balance. It can be difficult, however, for a customer to reconcile costs and payments associated with statement-based billing information. For example, a customer may find it hard to associate a portion of a total balance with a particular project. Similarly, when the customer makes a payment associated with a particular transaction, it may be difficult to review later statements to determine which transactions have not yet been paid. This can result in a large volume of telephone calls placed from to customer service representatives, which can be expensive and inefficient.

A customer may instead receive invoice-based billing information. In the case of a commercial account with a supplier, for example, a customer typically receives from the supplier a separate invoice for each transaction between the customer and the supplier (e.g., the customer may receive a separate invoice for a number of different shipments that have been received by the customer). In this case, the customer can provide separate payments for each invoice.

The invoice-based billing approach helps a customer reconcile costs. For example, the customer may be able to associate a particular invoice (and the amount of that invoice) with a particular project. The typical invoice-based billing approach, however, has a number of disadvantages. For example, it could be inefficient to print and send a large number of invoices to a customer via postal mail. Similarly, it can be difficult for the customer to receive and process a large number of invoices. This may be especially true for commercial customers, who are often involved in a significant number of transactions. Moreover, the customer needs to keep track of each separate invoice (e.g., to determine which invoices have been completely paid, partially paid, and/or not paid at all).

### SUMMARY

To alleviate problems inherent in the prior art, the present invention introduces systems and methods for providing invoice-based billing information associated with a credit card transaction.

According to one embodiment, information associated with a customer's credit card transaction is received. It is then arranged through a communication network for invoice-based billing information associated with the credit card transaction to be provided via a customer device.

According to another embodiment, information associated with a customer's commercial credit card transaction, including a project identifier, is received by an invoice controller. The invoice controller then transmits to an address associated with the customer an electronic message indicating that invoice-based billing information is available. The electronic message also includes a link to a Web site. The invoice-based billing information, including the project identifier, is then transmitted via the Web site and a customer device. It is then arranged for the customer to provide payment on an invoice basis.

According to another embodiment, a customer provides credit card account information associated with a credit card transaction. In this case, invoice-based billing information associated with the credit card transaction is then received by the customer through a communication network.

One embodiment comprises: means for receiving information associated with a customer's credit card transaction; and means for arranging through a communication network for invoice-based billing information associated with the credit card transaction to be provided via a customer device.

Another embodiment comprises: means for receiving information associated with a customer's commercial credit card transaction, the received information including a project identifier; means for transmitting to an address associated with the customer an electronic message indicating that invoice-based billing information is available, the message including a link to a Web site; means for transmitting the invoice-based billing information, including the project identifier, via the Web site and a customer device; and means for arranging for the customer to provide payment on an invoice basis.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram of a transaction system according to some embodiments of the present invention.

FIG. 2 is a flow chart of a method according to some embodiments of the present invention.

FIG. 3 is an information flow diagram according to some embodiments of the present invention.

FIG. 4 illustrates an enrollment display according to one embodiment of the present invention.

FIG. 5 illustrates an account display according to one embodiment of the present invention.

FIG. 6 illustrates an invoices display according to one embodiment of the present invention.

FIG. 7 illustrates a payment display according to one embodiment of the present invention.

FIG. 8 is a block diagram overview of an invoice controller according to an embodiment of the present invention.

FIG. 9 is a tabular representation of a portion of a customer database according to an embodiment of the present invention.

FIG. 10 is a tabular representation of a record in an invoice database according to an embodiment of the present invention.

FIG. 11 is a flow chart of a computer-implemented method according to some embodiments of the present invention.

FIGS. 12 through 14 are a flow chart of a method according to some embodiments of the present invention.

FIG. 15 is a flow chart of a method performed by a customer according to an embodiment of the present invention.

### DETAILED DESCRIPTION

Embodiments of the present invention are directed to systems and methods for providing invoice-based billing information associated with a credit card “transaction.” As used herein, the term “transaction” may refer to, for example, a customer's purchase of an item (e.g., a good or a service) from a merchant. A transaction may also be associated with, for example, a license or a rental agreement between a customer and a merchant. Moreover, as used herein, a “credit card” transaction may be associated with any type of credit card account, including, for example, a general credit card account, a co-branded credit card account, a private label credit card account, a personal credit card account, and/or a commercial credit card account.

Transaction System

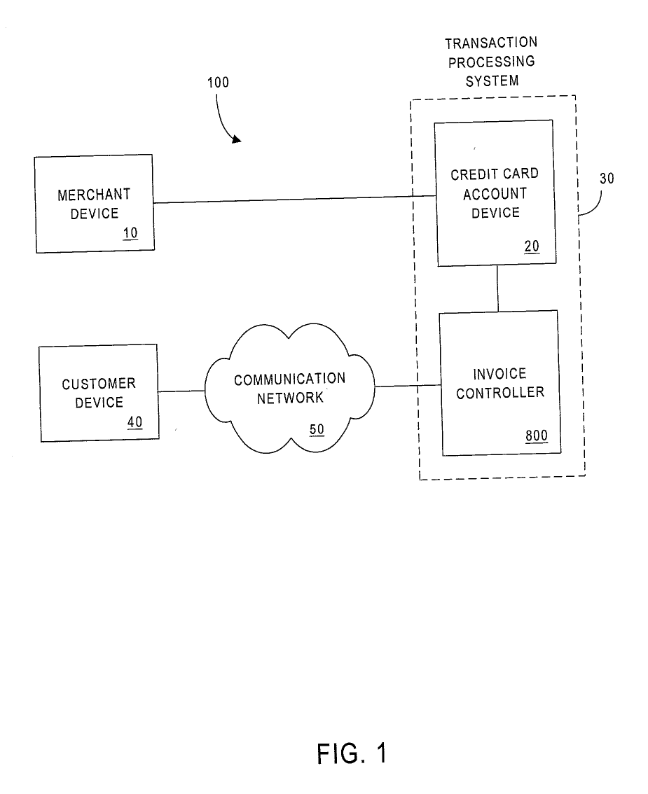

Turning now in detail to the drawings, FIG. 1 is a block diagram of a transaction system 100 according to some embodiments of the present invention. The transaction system 100 includes a merchant device 10 in communication with a credit card account device 20. The merchant device 10 may be, for example, a Point Of Sale (POS) terminal, a Credit Authorization Terminal (CAT) device, or a server associated with a merchant.

The credit card account device 20 is also in communication with an invoice controller 800. The credit card account device 20 and the invoice controller 800 may be any devices capable of performing the various functions described herein. For example, these devices may be Web-based servers and/or devices that communicate via proprietary networks. Note that the credit card account device 20 and the invoice controller 800 may be viewed as (and/or incorporated into) a single transaction processing system 30.

The invoice controller 800 communicates with a customer device 40 through a communication network 50. The communication network 50 may comprise, for example, a Local Area Network (LAN), a Metropolitan Area Network (MAN), a Wide Area Network (WAN), a proprietary network, a Public Switched Telephone Network (PSTN), a Wireless Application Protocol (WAP) network, or an Internet Protocol (IP) network such as the Internet, an intranet or an extranet. The customer device 40 may be any device capable of performing the various functions described herein. The customer device 40 may be, for example, a Personal Computer (PC) adapted to run a Web browser application (e.g., the INTERNET EXPLORER® application available from MICROSOFT®), a portable computing device such as a laptop computer or a Personal Digital Assistant (PDA), and/or a wireless telephone.

Note that the devices shown in FIG. 1 need not be in constant communication. For example, the invoice controller 800 may communicate with the credit card account device 20 on an as-needed or periodic basis. Moreover, although a single merchant device 10, credit card account device 20, invoice controller 800, and customer device 40 are shown in FIG. 1, any number of these devices may be included in the transaction system 100.

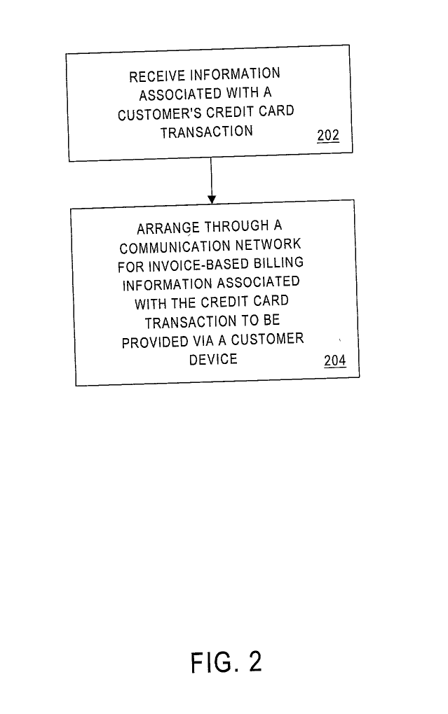

According an embodiment of the present invention, the transaction processing system 30 facilitates credit card transactions. In particular, FIG. 2 is a flow chart of a method that may be performed, for example, by the invoice controller 800 according to some embodiments of the present invention. The flow charts in FIG. 2 and the other figures described herein do not imply a fixed order to the steps, and embodiments of the present invention can be practiced in any order that is practicable.

At 202, information associated with a customer's credit card transaction is received. For example, the invoice controller 800 may receive credit card transaction information from the credit card account device 20 (e.g., based on information that was originally received by the credit card account device 20 from the merchant device 10). The received information may include, for example, a credit card account identifier (e.g., a credit card number), a merchant identifier, an invoice date, one or more invoice amounts (e.g., a total invoice amount or itemized invoice amounts), and/or one or more item descriptions (e.g., describing goods or services that were purchased by the customer). The received information may also include a buyer identifier (e.g., when a number of different buyers are associated with a commercial credit card account).

According to one embodiment, the information received by the invoice controller 800 also includes a project identifier. The project identifier may be, for example, a project name or code, a purchase order identifier, and/or job number that the customer associates with the transaction. The project identifier may be based on, for example, information provided from the customer to the merchant during the transaction (e.g., by verbally providing a project code to a POS terminal operator). According to one embodiment, the customer can subsequently provide (or adjust) the project identifier associated with a particular transaction (e.g., by accessing a Web site and entering an appropriate project name).

At 204, it is arranged through the communication network 50 for invoice-based billing information associated with the credit card transaction to be provided via the customer device 40. For example, the invoice controller 800 may transmit some or all of the following invoice-based billing information to the customer device 40: merchant information (e.g., a merchant identifier, name, and/or address), an invoice date (e.g., reflecting the date of the transaction between the customer and the merchant), an invoice identifier (e.g., an invoice number), one or more invoice amounts (e.g., a total invoice amount or itemized invoice amounts), an invoice balance (e.g., a total outstanding amount associated with the invoice), an invoice status (e.g., indicating whether or not the invoice has been paid or previously viewed by the customer), and/or one or more item descriptions (e.g., describing goods or services that were purchased by the customer).

Other information can also be transmitted from the invoice controller 800 to the customer device 40. For example, customer information (e.g., a customer identifier, name, and/or address) and a credit card account identifier may be transmitted through the communication network 50. According to one embodiment, the project identifier provided by the customer during the transaction is transmitted to the customer device 40.

The information transmitted through the communication network 50 may be used, for example, to display information to the customer via a Web site or an electronic mail message. Because the information is transmitted through the communication network 50, it may not be necessary to send a paper copy of the information via postal mail (e.g., providing increased efficiency for both the transaction processing system 30 and the customer).

According to one embodiment, the invoice controller 800 initially transmits an electronic mail message to the customer device 40 indicating that invoice-based billing information is available. For example, the customer may have previously designated a number of electronic mail addresses (e.g., a primary address and a number of secondary addresses) that should receive such messages. Note that the message itself might only include an identifier adapted to be used by the customer to retrieve the invoice-based billing information (e.g., a link to a Web site). That is, the electronic mail message itself might not contain the invoice-based billing information (e.g., for security purposes). Instead, the customer can use the identifier to receive the information (e.g., by activating a link to a Web site).

Information may be transmitted from the invoice controller 800 to the customer device 40 on an invoice-by-invoice basis (e.g., a separate electronic mail message may be received by the customer device 40 for each credit card transaction). According to another embodiment, the information is instead transmitted on a periodic basis (e.g., on a daily or weekly basis). According to still another embodiment, the information is transmitted in response to a request by the customer. Of course, more than one of these approaches (or any other approach) could be used.

The invoice-based billing information may be provided to the customer in a number of different ways. For example, a list of invoices may be displayed on a Web page sorted by the invoice date, the invoice amount, the outstanding balance, and/or the project identifier that the customer associated with the transaction. According to one embodiment, the information is displayed in accordance with the customer's preferences (e.g., the customer may request that invoices be sorted based on the project identifier).

According to another embodiment, statement-based billing information can also be provided via the customer device 40. For example, the customer may be allowed to switch between invoice-based and statement-based views of the credit card account. According to another embodiment, invoice-based billing information is displayed for all transactions that are currently associated with a project identifier and statement-based billing information is displayed for all other transactions (e.g., for the remaining transactions that are not currently associated with any project identifier).

According to still another embodiment, a customer uses the customer device 40 to associate customer notation information with a transaction. For example, a customer may provide a code explaining why some or all of an outstanding balance has not been paid. In this case, a customer service representative may be able to view the explanation without contacting the customer.

As another example, consider a hotel's credit card account that is accessed by two users: (i) a manager, and (ii) an employee in the hotel's accounting department. In this case, the notation information can be to exchange information between the two users. For example, the manager may enter “APR” as notation information via his or her customer device 40 (and the invoice controller 800 would then store that notation information). When the employee in the accounting department later accesses the invoice-based billing information, he or she would see the “APR” notation information (e.g., and understand that the transaction has already been approved by the manager).

Other information might also be transmitted from the invoice controller 800 to the customer device 40. For example, the invoice controller 800 may transmit some or all of the following to the customer device 40: enrollment confirmation information (e.g., informing the customer that paper invoices will no longer be mailed), reminder information (e.g., reminding a customer when an invoice is delinquent for more than 90 days), payment schedule information (e.g., informing the customer that bank funds have been electronically transferred in accordance with a previously requested payment schedule), payment confirmation information (e.g., informing the customer that a payment check has been received), and payment history information (e.g., a list of all payments that have been made in the last 180 days).

Information may also be transmitted from the customer device 40 to the invoice controller 800. For example, the customer device 40 may transmit enrollment information (e.g., one or more electronic mail addresses and bank account numbers) and/or account adjustment information (e.g., a revised customer address) to the invoice controller 800.

Note that a credit card account, such as a commercial credit card account, may be associated with a number of different users (e.g., a number of different buyers, employees, and/or customer service representatives). In this case, the invoice controller 800 may restrict access to the invoice-based billing information. For example, one user (e.g., having a first user name and password) may be allowed to view and edit information while another user (e.g., having a second user name and password) is only allowed to view information. Also note that a number of different credit card accounts may be associated with each other. For example, a “parent” credit card account may be associated with a number of different “child” accounts (or even “grandchild” accounts). In this case, one credit card account may be allowed to view information and/or make payments in connection with other associated accounts. Similarly, a report (e.g., a printed or electronic report) can be generated to consolidate information related to a number of associated accounts.

According to one embodiment, the transaction processing system 30 is also used by a customer to provide payment on an invoice basis. For example, a customer may use a customer device 40 to generate printed invoice-based billing information (e.g., a remittance stub to be mailed with a payment check).

According to another embodiment, payment can be provided with at least one pre-stored bank account identifier. For example, a customer may provide one or more bank account identifiers when enrolling to use the transaction processing system 30. In this case, the invoice controller 800 may receive from the customer device 40 invoice-based allocation information associated with a payment amount. For example, a customer may indicate that $60.00 of a $100.00 electronic bank transfer (e.g., associated with a pre-stored bank account identifier) should be allocated to one invoice and the remaining $40.00 should be allocated to a second invoice. According to still another embodiment, a customer can schedule a future payment. For example, a customer may indicate that a total invoice balance should be automatically be paid via an electronic bank transfer on a particular date.

Transaction Example

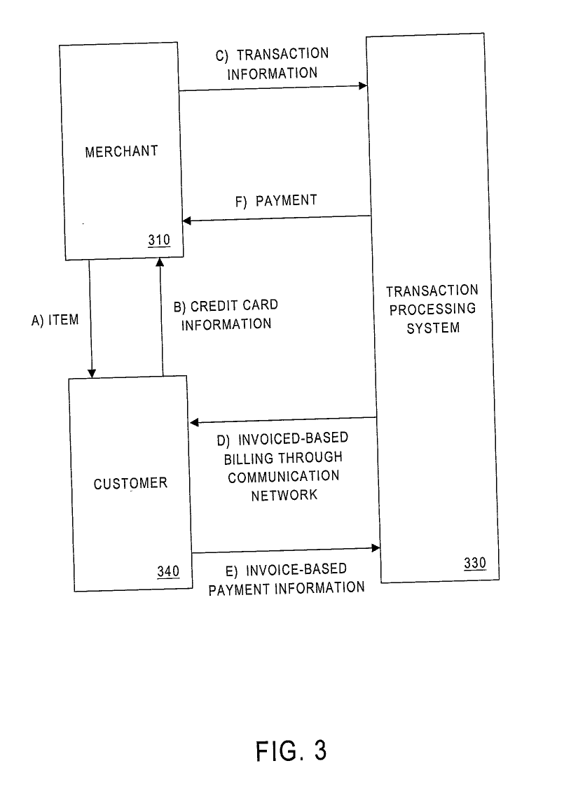

FIG. 3 is an information flow diagram according to some embodiments of the present invention. In particular, the flow diagram is associated with a customer 340 that has enrolled to used a transaction processing system 330.

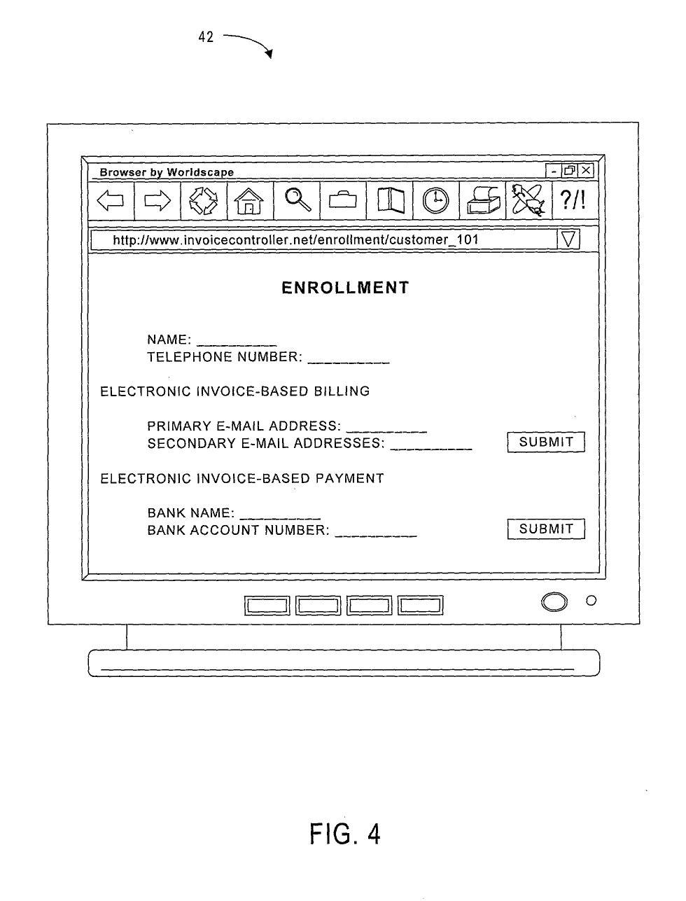

An example of a display 42 that might be used by the customer 340 during enrollment is illustrated in FIG. 4. As can be seen, the customer 340 can use this display 42 to provide a customer name and telephone number. The customer 340 may also provide electronic invoice-based billing information, such as a primary electronic mail address and one or more secondary electronic mail addresses (e.g., by activating the associated “submit” icon). Similarly, the customer 340 can provide electronic invoice-based payment information, such as a bank name and bank account number (e.g., by activating the associated “submit” icon). Other information, such as a routing transit number and/or information about additional bank accounts may also be provided. According to some embodiments, the customer 340 can elect to enroll in one or both of these two programs (e.g., the billing program and/or the payment program).

Referring again to FIG. 3, the customer 340 receives an item from a merchant 310 at (A) in exchange for providing credit card information at (B). For example, the customer 340 (e.g., an employee of the customer) may receive goods or services from the merchant 310 in exchange for providing a commercial credit card account number. Note that the customer 340 might also provide a project identifier to the merchant 310 at this time (e.g., a project identifier that indicates the customer associates the transaction with a “Jones” project).

At (C), the merchant 310 transmits transaction information to a transaction processing system 330. For example, the merchant 310 may transmit a merchant identifier, a credit card number, a transaction amount, and a project identifier to the transaction processing system 330.

At (D), the transaction processing system 330 transmits invoice-based billing information to the customer 340 through a communication network. For example, the transaction processing system 330 may transmit an electronic mail message to the customer 340 indicating that new invoice-based billing information is available. The message may include, for example, a link to a Web site that the customer 340 can activate to receive the information.

The customer 340 then accesses the Web site. Note that the customer may be required to provide an appropriate user name and password before receiving the billing information. According to another embodiment, a customer device stores a security code lets the customer 340 to receive the billing information (e.g., the security code may be stored in a “cookie” file).

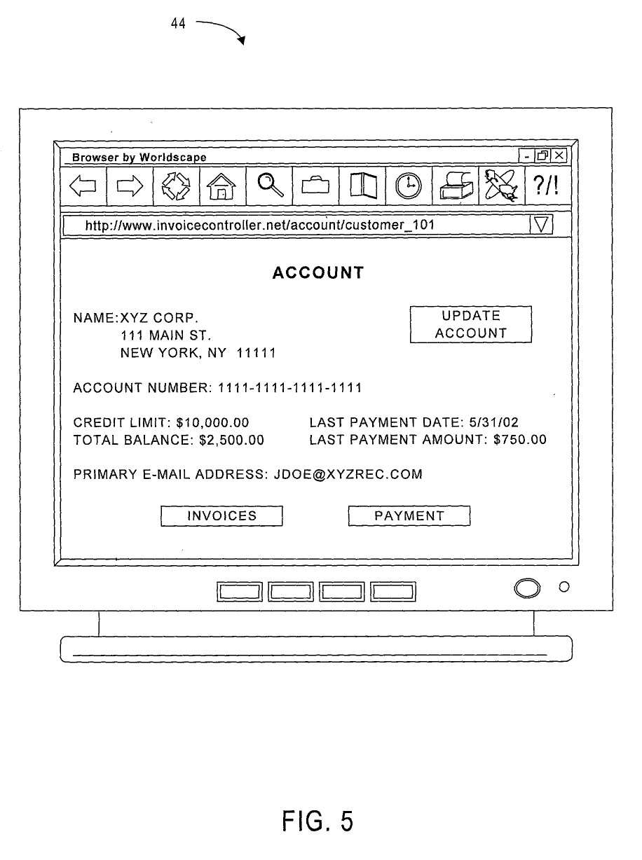

FIG. 5 illustrates an account display 44 that might be provided to the customer 340. The account display 44 includes the customer's name and address, a credit card account number, a credit limit and total (current) balance, the date and amount of the customer's last payment, and one or more electronic mail addresses (e.g., addresses to which invoice notification messages will be transmitted). Other account information might also be displayed, such as a list of authorized users, (e.g., users who are allowed to access the information), a list of authorized buyers (e.g., user who are allowed to make purchases), information about a customer service representative or account manager (e.g., a manager assigned to a particularly important commercial credit card account), and/or details about the terms and conditions that are associated with the credit card account.

The account display 44 may also let the customer adjust the account information (i.e., via an “update account” icon), view invoice information (i.e., via an “invoices” icon), and/or arrange to provide payment (i.e., via a “payment” icon).

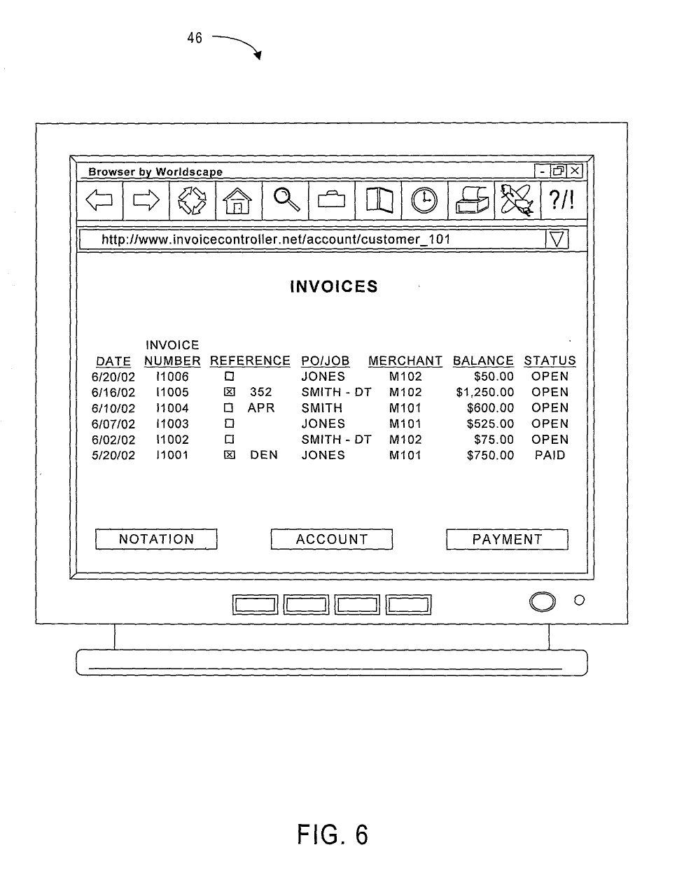

If the customer 340 activates the “invoices” icon, an invoices display 46 such as the one illustrated in FIG. 6 may be provided. The invoices display 46 includes a number of different invoices and, for each invoice, provides an invoice date, an invoice number, a Purchase Order (PO) or job identifier (i.e., a project identifier), a merchant identifier, an invoice balance, and an invoice status. The invoice status may indicate, for example, that an invoice is “open” (e.g., not paid) or “paid.” The invoices display 46 also lets a customer 340 provide reference information (e.g., a reference code). According to one embodiment, a “due date” associated with each invoice is also displayed. According to another embodiment, another indication is displayed to reflect whether or not an invoice has already been viewed by the customer. According to other embodiments, the invoices display 46 also indicates a check number (if any) that was used to provide payment and/or an original amount associated with each invoice (e.g., before any payment was made by the customer).

The invoices may sorted, for example, based on any associated information (e.g., invoice dates or project identifiers). According to one embodiment, the customer 340 can select how the invoices should be sorted (e.g., by activating appropriate column headings). According to another embodiment, the customer can select one or more invoices to receive further details about the transaction (e.g., a buyer identifier and a list of items that were purchased).

The invoices display 46 also lets the customer 340 provide notation information about an invoice (i.e., via a “notation” icon). For example, the customer 340 may indicate whether or not an accounting department has approved a particular invoice for payment. Similarly, the invoices display 46 lets the customer 340 access the account display 44 (i.e., via an “account” icon) and/or arrange to provide payment (i.e., via a “payment” icon).

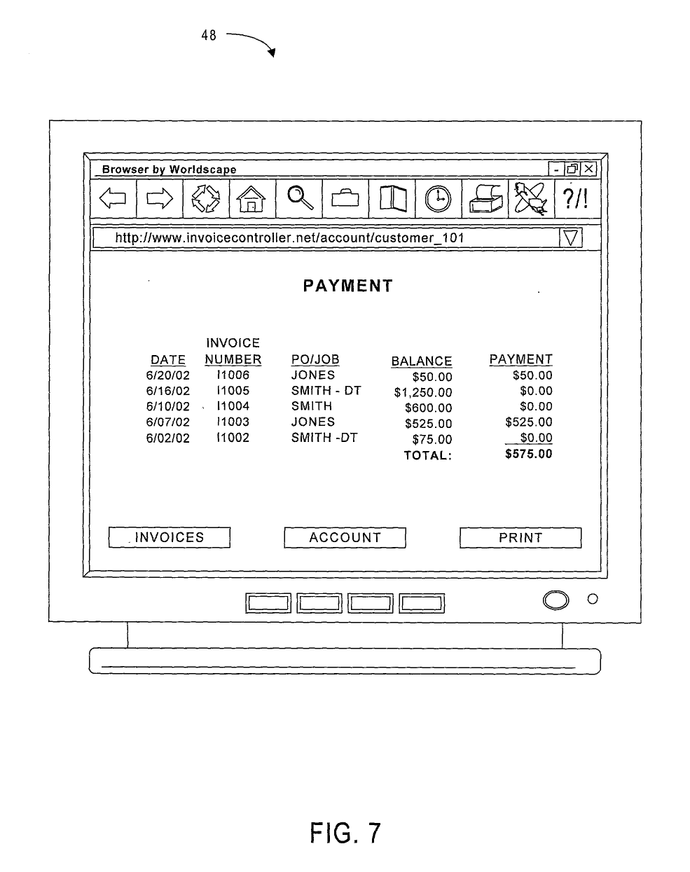

If the customer 340 activates the “payment” icon, a payment display 48 such as the one illustrated in FIG. 7 may be provided. The payment display 48 includes a number of different invoices and, for each invoice, provides an invoice date, an invoice number, a PO or job identifier (i.e., a project identifier), and an invoice balance. The invoices may be sorted, for example, based on invoice dates, project identifiers, and/or balances. According to one embodiment, the customer 340 can select how the invoices should be sorted (e.g., by activating appropriate column headings).

The customer 340 can then enter payment information via the payment display 48. For example, the customer 340 may indicate a number of different payment amounts that should be associated with different invoices. As illustrated in FIG. 7, the customer 340 has indicated that a $50.00 payment should be applied to invoice number “I1006” and a $525.00 payment should be applied to invoice number “I1003.” A total payment amount may then be computed and displayed to the customer 340 (i.e., $50.00+$525.00=$575.00).

The customer may provide payment, for example, using the bank account number that was previously provided via the enrollment display 42. The customer 340 may instead active a “print” icon to generate a remittance stub to be mailed with a payment check (e.g., the remittance stub may be generated by a printer coupled to the customer device 40).

The payment display 48 also lets the customer 340 access the invoices display 46 (e.g., via an “invoices” icon) and the account display 44 (e.g., via an “account” icon).

Referring again to FIG. 3, invoice-based payment information (e.g., a total payment amount and associated invoice allocation information) is transmitted from the customer 340 to the transaction processing system 330 at (E). The transaction processing system 330 then arranges for payment to be provided to the merchant 310 at (F) to complete the transaction.

Transaction Controller

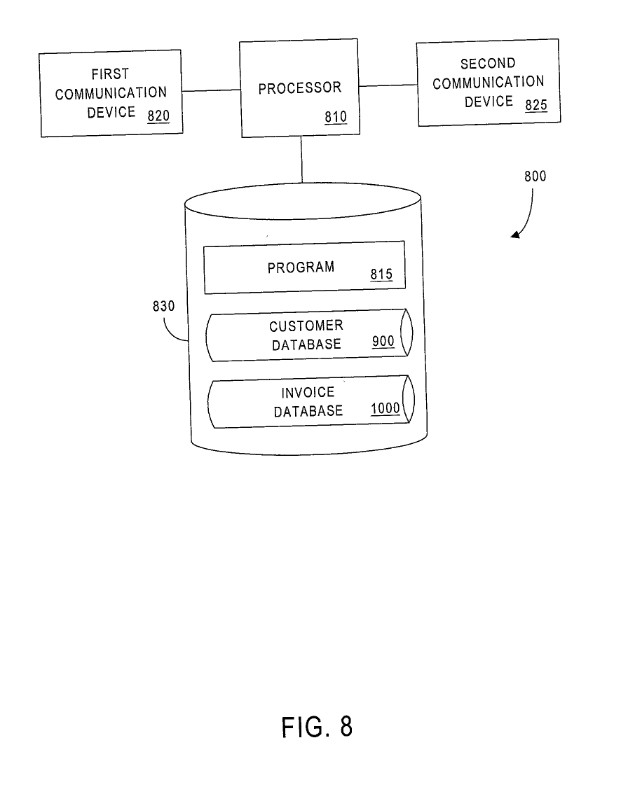

FIG. 8 illustrates an invoice controller 800 that is descriptive of the device shown, for example, in FIG. 1 according to some embodiments of the present invention. The invoice controller 800 includes a processor 810, such as one or more INTEL® Pentium® processors. The processor 810 is coupled to a first communication device 820 that may be used, for example, to communicate with one or more credit card account devices 20. The processor 810 is also coupled to a second communication device 825 that may be used to communicated with one or more customer devices 40 (e.g., via the communication network 50). Of course, a single communication device may instead be used to communicate with both credit card account devices 20 and customer devices 40. Moreover, the processor 810 may additionally communicate with merchant devices 10 and/or other invoice controllers 800 according to some embodiments of the present invention.

The processor 810 is also in communication with a storage device 830. The storage device 830 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 830 stores a program 815 for controlling the processor 810. The processor 810 performs instructions of the program 815, and thereby operates in accordance with the present invention. For example, the processor 810 may receive information associated with a customer's credit card transaction. The processor 810 may then arrange through the communication network 50 for invoice-based billing information associated with the credit card transaction to be provided via a customer device 40.

According to one embodiment, the processor 810 receives information associated with a customer's commercial credit card transaction, the received information including a project identifier. The processor 810 then transmits to an address associated with the customer an electronic mail message indicating that invoice-based billing information is available, the message including a link to a Web site. The processor 810 also transmits the invoice-based billing information, including the project identifier, via the Web site and a customer device 40. The processor 810 then arranges for the customer to provide payment on an invoice basis.

As used herein, information may be “received” by or “transmitted” to another device, a software application within the invoice controller 800, and/or any other source.

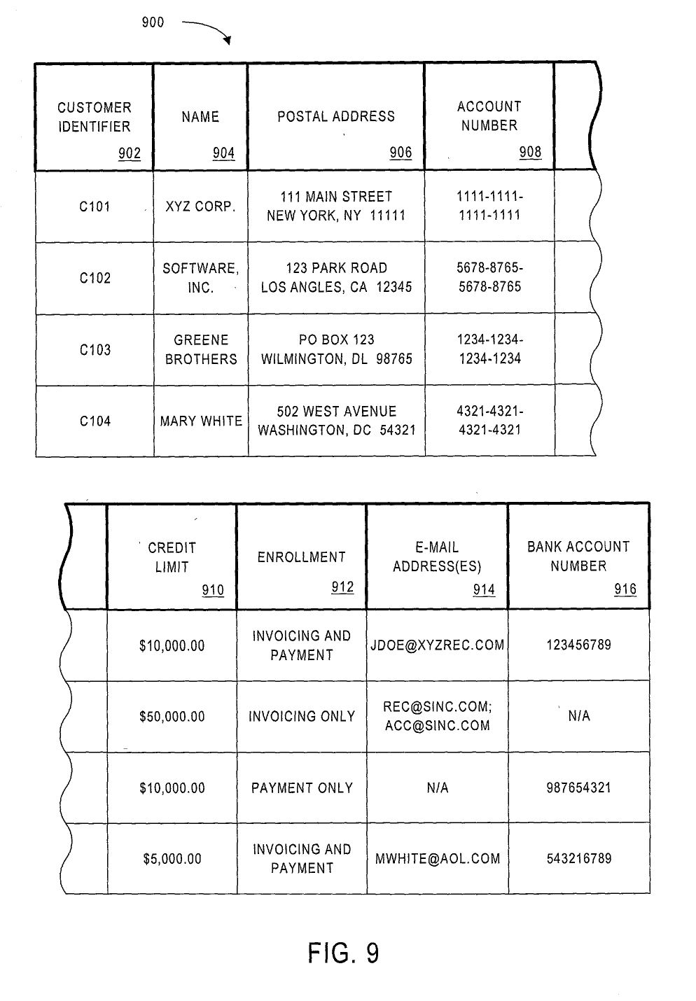

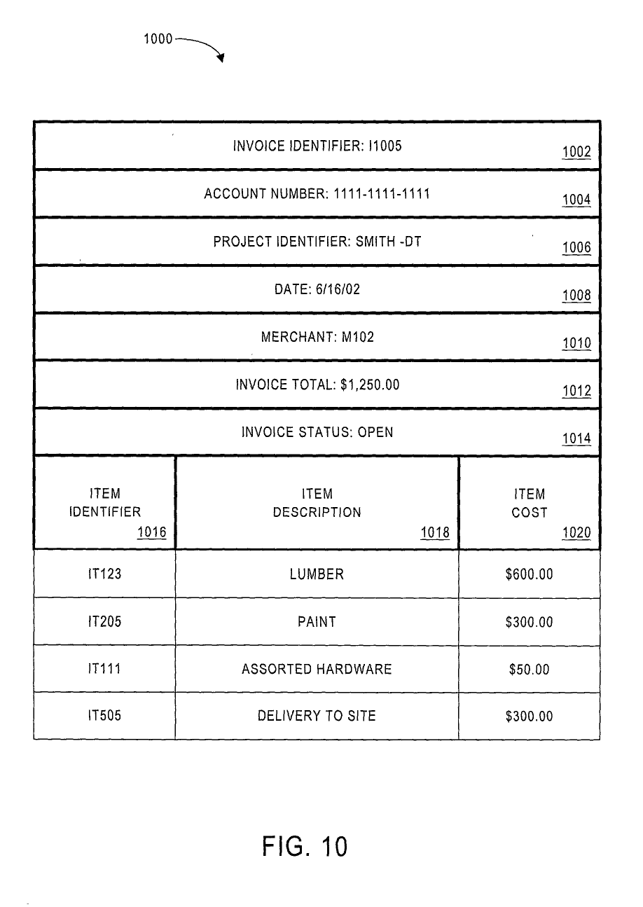

As shown in FIG. 8, the storage device 830 also stores a customer database 900 (described with respect to FIG. 9) and an invoice database 1000 (described with respect to FIG. 10). Examples of databases that may be used in connection with the invoice controller device 800 will now be described in detail. The illustrations and accompanying descriptions of the databases presented herein are exemplary, and any number of other database arrangements could be employed besides those suggested by the figures.

Customer Database

Referring to FIG. 9, a table represents the customer database 900 that may be stored at the invoice controller 800 according to an embodiment of the present invention. The table includes entries identifying customers who may receive invoice-based billing information via the transaction system 100. The table also defines fields 902, 904, 906, 908, 910, 912, 914, 916 for each of the entries. The fields specify: a customer identifier 902, a name 904, a postal address 906, an account number 908, a credit limit 910, an enrollment 912, one or more e-mail addresses 914, and one or more bank account numbers 916. The information in the customer database 900 may be created and updated, for example, based on information received from a customer during an enrollment process and/or information received from a credit card account device 20.

The customer identifier 902 may be, for example, an alphanumeric code associated with a particular customer who may receive invoice-based billing information via the transaction system 100. The customer identifier 902 may be generated by, for example, the credit card account device 20, the invoice controller 800, and/or the customer (e.g., when the customer selects a user name and password during an enrollment). The customer name 904 and the postal address 906 indicate an account name and a mailing address associated with the customer's credit card account, respectively. Similarly, the account number 908 and credit limit 910 may represent a credit card number and credit limit, respectively.

The enrollment 912 indicates if the customer is enrolled in an electronic invoice-based billing program and/or an electronic invoice-based payment program (e.g., based on the customer's submissions via the enrollment display 42 shown in FIG. 4).

For customers who are enrolled in the electronic invoice-based billing program, the e-mail addresses 914 indicate where an electronic mail message will be transmitted when new invoice information becomes available. For customers who are enrolled in the electronic invoice-based payment program, the bank account number 916 will be used to transfer funds in connection with invoice-based payments.

Invoice Database

Referring to FIG. 10, a table represents a record in the invoice database 1000 that may be stored at the invoice controller 800 according to an embodiment of the present invention. The database includes records associated with transactions processed via the transaction system 100. The information in the invoice database 1000 may be created and updated, for example, when a customer purchases an item and/or provides a payment via the transaction system 100.

As shown in FIG. 10, each record indicates an invoice identifier 1002 associated with the transaction. An account identifier 1004 indicates a credit card account associated with the transaction and may be based on, or associated with, the account number 908 stored in the customer database 900. Each record also includes a project identifier 1006 that the customer associates with the transaction (e.g., a code or an alphanumeric field). A date 1008 indicates a date (and possibly a time) and the merchant 1010 indicates a merchant associated with the customer's transaction. The invoice total 1012 indicates a total amount associated with the transaction (e.g., an amount the customer will pay in exchange for one or more items). An invoice status 1014 indicates whether the invoice is “open” (i.e., not yet paid in full) or “paid.”

The table also defines fields 1016, 1018, 1020 for each record. The fields specify: an item identifier 1016, an item description 1018, and an item cost 1020. The item identifier 1016 indicates an item (e.g., a good or service) that was purchased by the customer, and the description 1018 describes the item. The item cost 1020 indicates an amount the customer will pay customer in exchange for the item. Note that the invoice total 1012 may be calculated by adding each item cost 1020 associated with the invoice.

According to another embodiment, the invoice database 1000 stores a project identifier on an item-by-item basis. That is, a single transaction may be associated with a number of different project identifiers. According to another embodiment, a single transaction may be associated with a number of different invoices. Similarly, a single invoice may be associated with a number of different transactions (e.g., a single daily invoice may be created for every transaction having a projection identifier of “Smith”).

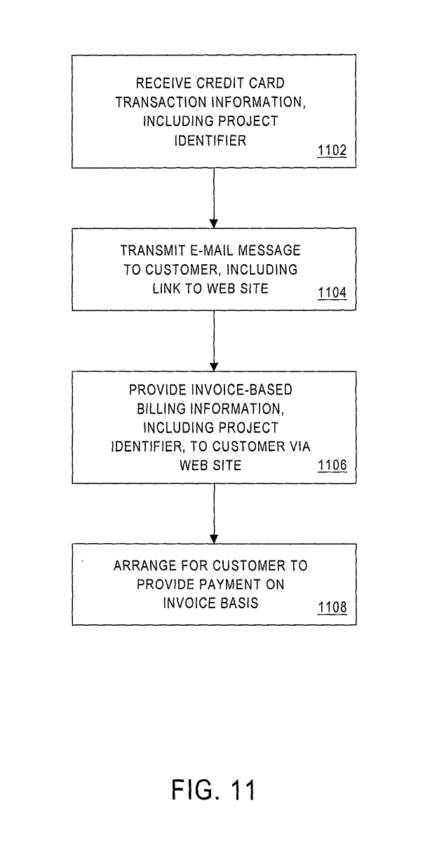

Methods that may be used in connection with the transaction system 100 according to some embodiments of the present invention will now be described in detail with respect to FIG. 11 through 15.

Transaction Methods

FIG. 11 is a flow chart of a computer-implemented method according to some embodiments of the present invention. The method may be performed, for example, by an invoice controller 800 that communicates with a customer device 40.

At 1102, information associated with a customer's commercial credit card transaction, including a project identifier, is received. For example, the invoice controller 800 may receive this information from a credit card account device 20.

At 1104, an electronic mail message is transmitted to an address associated with the customer and/or a customer device 40. The message indicates that invoice-based billing information is available and may include a link to a Web site through which the customer can access the information. For example, the invoice controller 800 may send a message to one or more e-mail addresses 914 stored in the customer database 900 (e.g., based on information provided by the customer via the enrollment display 42 described with respect to FIG. 4).

At 1106, invoice-based billing information, including the project identifier, is provided to the customer device 40 via the Web site. For example, the customer may activate the link in the electronic mail message to access an account display 44 (described with respect to FIG. 5) or an invoices display 46 (described with respect to FIG. 6).

At 1108, is arranged for the customer to provide payment on an invoice basis. For example, the customer may access the payment display 48 described with respect to FIG. 7. In this case, the invoice controller 800 may receive invoice-based payment information from the customer device 40.

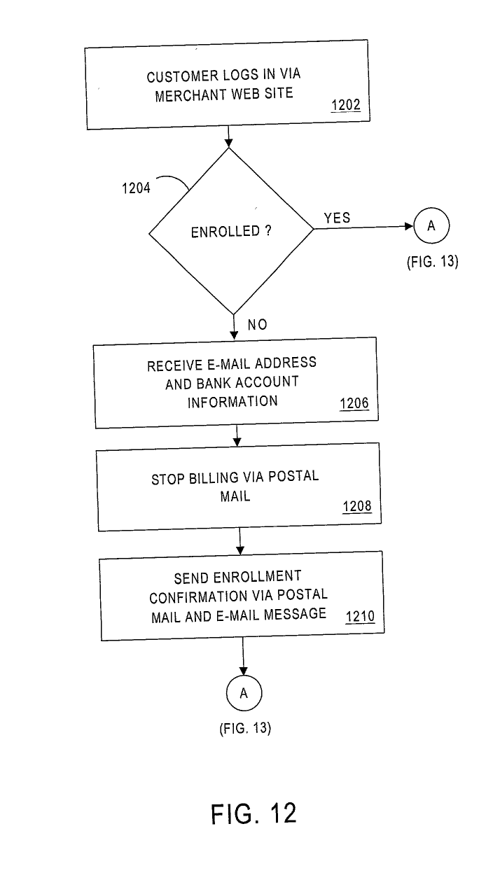

FIGS. 12 through 14 are a flow chart of another method according to some embodiments of the present invention. At 1202, a customer performs a log in process to access invoice-based billing information (e.g., by providing a user name and password). Note that this process may be associated with a credit card company, a merchant, or a third-party Web site (e.g., a customer may access invoice-based billing information associated with a private label credit card via a HOME DEPOT® Web site).

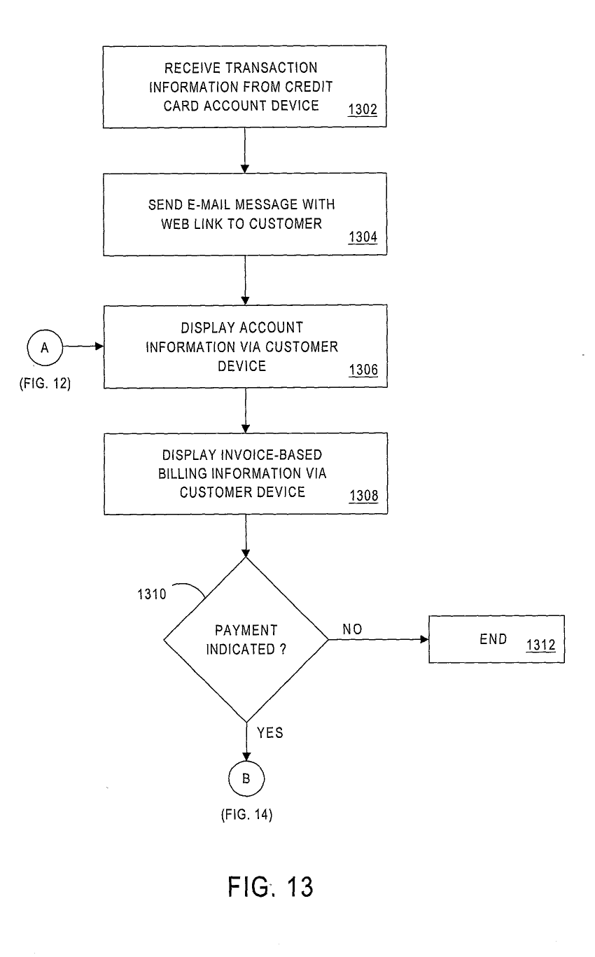

If the customer is enrolled in one or more electronic invoice-based billing programs at 1204, the processes continues at “A” (i.e., at 1306 in FIG. 13). If the customer is not enrolled, information about one or more electronic mail addresses and/or bank accounts may be received from the customer at 1206 (e.g., the invoice controller 800 may let the customer access a link to the enrollment display 42 described with respect to FIG. 4). The invoice controller 800 then stores this information in the customer database 900.

The sending of invoice-based billing information via postal mail is then stopped at 1208. That is, because the customer can access the billing information via the communication network 50, it is no longer necessary to mail paper invoices. An enrollment confirmation is also sent to the customer via postal mail and/or an electronic mail message. The processes then continues at “A” (i.e., at 1306 in FIG. 13).

Referring now to FIG. 13, transaction information associated with the customer is received from a credit card account device 20 at 1302. For example, the invoice controller 800 may receive the transaction information from the credit card account device 20 in accordance with information originally transmitted from the merchant device 10. Based on the transaction information, the invoice controller 800 updates the invoice database 1000 and sends an electronic mail message, including a link to an appropriate Web page or Web site, to the customer at 1304.

At 1306, the customer accesses the Web site, and the appropriate account information is displayed via the customer device 40. For example, the transaction controller 800 may retrieve the account information from the customer database 900 and arrange for the account display 44 (described with respect to FIG. 5) to be displayed via the customer device 40.

At 1308, the appropriate invoice information is displayed via the customer device 40. For example, the transaction controller 800 may retrieve the account information from the invoice database 1000 and arrange for the invoices display 46 (described with respect to FIG. 6) to be displayed via the customer device 40.

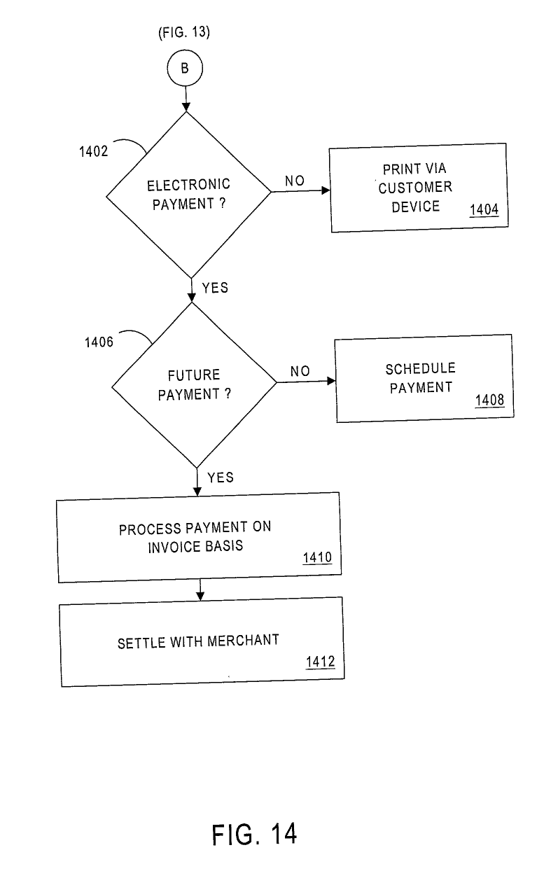

If the customer does not indicate that a payment will be made at 1310, the process ends at 1312. If the customer does indicate that a payment will be made, the invoice controller 800 determines at 1402 (FIG. 14) whether or not the payment will be made via an electronic transfer of funds from a bank account.

If the payment will not be made via an electronic transfer at 1402, a remittance stub is printed via the customer device 40 at 1404. The customer can then mail the remittance stub via postal mail along with a payment check.

If the payment will be made via an electronic transfer, the invoice controller 800 determines at 1406 whether or not the payment will made on a future date. If the payment will be made on a future date at 1406, the customer schedules the payment at 1408.

If the payment is not associated with a future date (i.e., the customer is making an immediate payment), the invoice controller 800 processes the payment information on an invoice basis (e.g., via the payment display 48 described with respect to FIG. 7). The invoice controller 800 may then facilitate a settlement with the merchant (e.g., by transmitting information to the credit card account device 20).

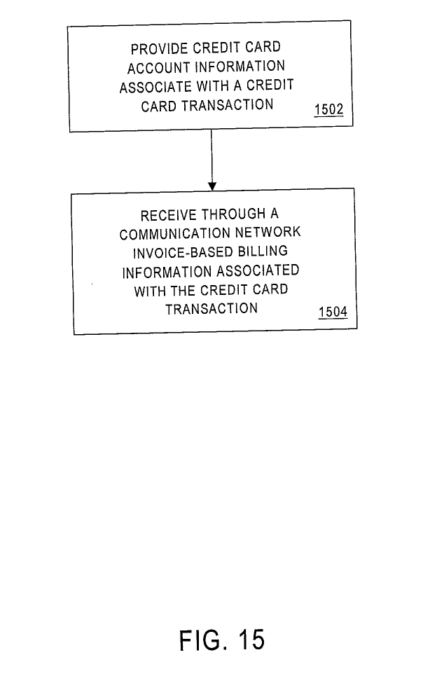

FIG. 15 is a flow chart of a method performed by a customer according to an embodiment of the present invention. At 1502, the customer provides credit card account information associated with a credit card transaction. For example, the customer may provide a commercial credit card number and project identifier to a merchant. At 1504, the customer receives through a communication network invoice-based billing information associated with the credit card transaction. For example, the customer may use a customer device 40 to access a Web site and receive invoice-based billing information.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although certain functions have been described with respect to the transaction processing system 30, other functions may also be incorporated into the present invention. For example, the transaction processing system 30 may also allow enhanced customer customization of billing information. In this case, a customer may be able to improve an internal approval processes because an accounts payable group by circulating invoices internally in electronic form (e.g., so that invoices can be reviewed and approved by the appropriate internal parties). According to one embodiment, such an electronic invoice will include an internal approval applet that can be activated with appropriate security controls by an online accounts payable manager. This applet may also record the various approvals or comments the invoice receives as it is circulated within the company.

Moreover, the accounts payable manger may be able to “program” the applet to generate a “reminder” message when an approver has not responded within a specified period of time. The applets may also be programmed to follow a variety of work flows and business rules (e.g., if an invoice amount is more than a threshold value, then the invoice needs approval from employees a, b, and c). An accounts manager may monitor and receive status reports on each invoice from a internal approval control module accessed off the account view page. Approvals and comments may be stored both in the transaction processing system 30 and the online internal control module along with customer-configurable reports and status “dashboards.”

According to one embodiment, invoices are circulated using the online account payable manager browser-based “send” functionality. According to another embodiment, this function is performed via full featured secured messaging provided by an Internet application. Part of this full functionality may be the ability to “point and click” where individual messages (or groups of messages) should be routed so that invoices can be routed quickly and easily.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating credit card transactions, comprising:
receiving information associated with a customer's credit card transaction; and
arranging through a communication network for invoice-based billing information associated with the credit card transaction to be provided via a customer device.

2. The method of claim 1, wherein the invoice-based billing information includes a project identifier that the customer has associated with the transaction.

3. The method of claim 1, wherein said arranging further comprises:
transmitting to an electronic mail address associated with the customer a message indicating that the invoice-based billing information is available.

4. The method of claim 3, wherein the message includes an identifier adapted to be used by the customer to retrieve the invoice-based billing information.

5. The method of claim 3, wherein said transmitting is performed at least one of: (i) on an invoice basis, (ii) on a periodic basis, and (iii) in response to a request by the customer.

6. The method of claim 3, wherein said transmitting is associated with a plurality of electronic mail addresses.

7. The method of claim 1, wherein said arranging further comprises:
sorting the invoice-based billing information on an invoice basis.

8. The method of claim 1, further comprising:
arranging for statement-based billing information to be provided via the customer device.

9. The method of claim 1, further comprising:
receiving customer notation information from the customer device; and
storing the customer notation information in association with the invoice-based billing information.

10. The method of claim 9, further comprising:
retrieving the customer notation information; and
arranging for the customer notation information to be provided via the customer device.

11. The method of claim 9, wherein the customer notation information comprises a notation code.

12. The method of claim 1, wherein a plurality of buyers are associated with the customer, and the invoice-based billing information includes a buyer identifier.

13. The method of claim 1, wherein said arranging is performed without sending the invoice-based billing information via postal mail.

14. The method of claim 1, further comprising:
arranging for printed invoice-based billing information to be generated via the customer device.

15. The method of claim 1, further comprising:
transmitting to the customer device at least one of: (i) enrollment confirmation information, (ii) reminder information, (iii) payment schedule information, (iv) payment confirmation information, and (v) payment history information.

16. The method of claim 1, further comprising:
receiving from the customer device at least one of: (i) enrollment information, and (ii) account adjustment information.

17. The method of claim 1, wherein the customer is associated with a plurality of users, and further comprising:
controlling a user's access to the invoice-based billing information.

18. The method of claim 17, wherein at least one user comprise a customer service representative.

19. The method of claim 1, further comprising:
arranging for the customer to provide payment on an invoice basis.

20. The method of claim 19, wherein the payment is provided with at least one pre-stored bank account identifier.

21. The method of claim 19, wherein the payment is provided with a bank check sent via postal mail.

22. The method of claim 19, wherein said arranging for the customer to provide payment comprises:
receiving invoice-based allocation information associated with a payment amount.

23. The method of claim 19, wherein said arranging for the customer to provide payment comprises:
scheduling a future payment.

24. The method of claim 1, wherein the received information includes at least one of: (i) a credit card account identifier, (ii) a merchant identifier, (iii) an invoice date, (iv) a project identifier, (v) an invoice amount, and (vi) an item description.

25. The method of claim 1, wherein the provided information includes at least one of: (i) a customer identifier, (ii) a customer name, (iii) a customer address, (iv) a credit card account identifier, (v) a merchant identifier, (vi) a merchant name, (vii) a merchant address, (viii) an invoice date, (ix) an invoice identifier, (x) an invoice amount, (xi) an invoice balance, (xii) an invoice status, and (xiii) an item description.

26. The method of claim 1, wherein the customer device comprises at least one of: (i) a personal computer, (ii) a portable computer, (iii) a personal digital assistant, and (iv) a wireless telephone.

27. The method of claim 1, wherein the communication network comprises at least one of: (i) an Internet protocol network, (ii) the Internet, (iii) a public network, (iv) a proprietary network, and (v) a wireless network.

28. An apparatus, comprising:
a processor; and
a storage device in communication with said processor and storing instructions adapted to be executed by said processor to:
receive information associated with a customer's credit card transaction, and
arrange through a communication network for invoice-based billing information associated with the credit card transaction to be provided via a customer device.

29. The apparatus of claim 28, wherein said storage device further stores at least one of: (i) a customer database, and (ii) an invoice database.

30. The apparatus of claim 28, further comprising:
a communication device coupled to said processor and adapted to communicate with at least one of: (i) a merchant device, (ii) a credit card account device, (iii) an invoice controller, (iv) a transaction processing system, and (v) a customer device.

31. A medium storing instructions adapted to be executed by a processor to perform a method of facilitating credit card transactions, said method comprising:
receiving information associated with a customer's credit card transaction; and
arranging through a communication network for invoice-based billing information associated with the credit card transaction to be provided via a customer device.

32. A computer-implemented method of facilitating commercial credit card transactions, comprising:
receiving information associated with a customer's commercial credit card transaction, the received information including a project identifier;
transmitting to an address associated with the customer an electronic message indicating that invoice-based billing information is available, the message including a link to a Web site;
transmitting the invoice-based billing information, including the project identifier, via the Web site and a customer device; and
arranging for the customer to provide payment on an invoice basis.

33. A method of purchasing items, comprising:
providing credit card account information associated with a credit card transaction; and
receiving through a communication network invoice-based billing information associated with the credit card transaction.
